(19) United States
(12) Patent Application Publication
(10) Pub. No.: US 2006/0125963 A1
(43) Pub. Date: Jun. 15, 2006

(54) Personal video recorder system and method for reproducing a broadcasting signal in the system

(75) Inventor: Kwan Seung Baek, Gumi-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/298,616

(22) Filed: Dec. 12, 2005

(30) Foreign Application Priority Data
Dec. 13, 2004 (KR) 10-2004-0104803

(51) Int. Cl. H04N 5/21; H04N 7/01; H04N 9/67; H04N 9/78; H04N 11/20; H04N 7/173

(52) U.S. Cl. 348/631; 348/450; 725/89; 348/659; 348/667; 725/134

(57) ABSTRACT

The present invention relates to a PVR (personal video recorder) system, which includes: a fist tuner and a second tuner for extracting an audio/video signal; a first signal processing unit for image-processing the video signal outputted from the A/V switch to reproduce a broadcasting channel tuned by the first tuner in real-time; a second signal processing unit for encoding the video signal outputted from the A/V switch to store the broadcasting channel tuned by the second tuner, which is the same as the broadcasting channel tuned by the first tuner; and a controller for displaying the video signal processed by the fist signal processing unit and/or the video signal processed by the second signal processing unit. In accordance with the present invention, a user can watch a screen of an improved noise since the video signal is not encoded by using an MPEG technique when a current broadcasting is reproduced.

### FIELD OF THE INVENTION

The present invention relates to a PVR (personal video recorder) system, and more particularly to a PVR system and a method for reproducing a broadcasting signal in the PVR system, which are capable of directly reproducing a video signal without using an MPEG encoding technique when a user wants to watch a current broadcasting in real-time thereby to prevent a deterioration of an image quality as well as reproducing a stored video signal when the user wants to watch a past broadcasting.

### BACKGROUND OF THE INVENTION

A PVR (personal video recorder), having a storage medium such as a HDD (hard disk drive) to record/reproduce a digital broadcasting, has been used to store a digital broadcasting input based on an MPEG-2 technology or an NTSC broadcasting input encoded by using the MPEG-2 technology into a digital storage medium. For this purpose, unlike the conventional decoder system, the PVR should have a basic configuration suitable for storing an input stream into a medium such as a hard disk drive during a recording mode and reading the stored stream from the medium and then transmitting the stream to a decoder during a reproducing mode.

Generally, since a PVR digital broadcasting receiver having a CPU of high performance records a broadcasting in a storage medium such as a hard disk drive for each file, a user can select a program he wants to watch in order to record the program in a reservation manner and watch the program repeatedly. For this purpose, the PVR has a mass storage medium, e.g., a hard disk drive, to store recorded data, i.e., broadcasting program data, therein and also has a function of reproducing the data stored in the storage medium.

Herein, the broadcasting program data stored in the storage medium have to be encoded by using an encoding technique such as an MPEG-2, in order to use the storage medium efficiently. Then, the stored data have to be decoded by using the corresponding decoding technique when a user wants to reproduce the data. Accordingly, a large amount of broadcasting program data can be recorded in the storage medium of the PVR.

Typically, the PVR records current broadcasting data in the mass storage medium and then reproduce the data immediately to display a current broadcasting. That is, in order to reproduce a current broadcasting program, the current broadcasting is encoded by using the MPEG and stored in the storage medium first.

Accordingly, even if a user watches a broadcasting in real-time, an image quality thereof is not satisfactory since a high-frequency signal is attenuated during an encoding process and a blocking noise occurs during a decoding process.

### SUMMARY OF THE INVENTION

Accordingly, the present invention has been made to solve the above-mentioned problems occurring in the prior art, and an object of the present invention is to provide a PVR system and a method for reproducing a broadcasting signal in the PVR system, which are capable of directly reproducing a video signal without using an MPEG encoding technique when a user want to watch a current broadcasting in real-time thereby to prevent a deterioration of an image quality as well as reproducing a stored video signal when the user want to watch a past broadcasting.

In accordance with one aspect of the present invention, there is provided a PVR system including: a first tuner and a second tuner for tuning into a channel among a plurality of broadcasting channels and extracting an audio/video signal from the tuned channel; an A/V switch for switching the audio/video signal extracted by the first and the second tuner; a first signal processing unit for image-processing the video signal outputted from the A/V switch to reproduce the broadcasting channel tuned by the first tuner in real-time; a second signal processing unit for encoding the video signal outputted from the A/V switch to store the broadcasting channel tuned by the second tuner, which is the same as the broadcasting channel tuned by the first tuner; a data storage unit for storing the video signal processed by the second signal processing unit; and a controller for displaying the video signal processed by the fist signal processing unit and/or the video signal processed by the second signal processing unit and stored in the data storage unit.

In accordance with another aspect of the present invention, there is provided a method for reproducing a broadcasting signal in a PVR system, including the steps of (a) processing a video signal through a first path to reproduce a broadcasting channel tuned by a first tuner in real-time; (b) tuning into a broadcasting channel by a second tuner, which is the same as the broadcasting channel tuned by the first tuner, and encoding and storing a video signal of the broadcasting channel along a second path; and (c) reproducing and displaying the video signal processed in the step (a) if a current mode for watching a real-time broadcasting is chosen, and reading and reproducing the video signal stored in the step (b) if a past mode for watching a past broadcasting is selected.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a PVR system in accordance with the present invention;

FIG. 2 is a screen displayed to a user in accordance with an embodiment of the present invention;

FIG. 3 is a flow chart of a PVR system in accordance with an embodiment of the present invention;

FIG. 4 is a flow chart of a PVR system in accordance with another embodiment of the present invention;

FIG. 5 is a flow chart of a PVR system in accordance with still another embodiment of the present invention; and

FIG. 6 is a flow chart of a PVR system in accordance with still another embodiment of the present invention.

### DETAILED DESCRIPTION OF THE PREFERRED EMBODIMENTS

Hereinafter, a preferred embodiment of the present invention will be described with reference to the accompanying drawings.

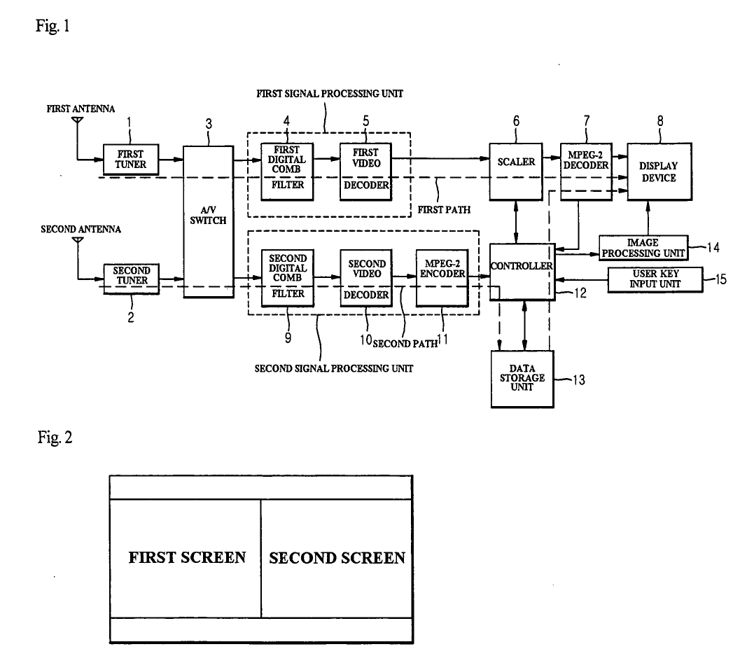

Referring to FIG. 1, a PVR (personal video recorder) system in accordance with the present invention includes a first tuner 1 and a second tuner 2 for extracting an audio/video signal received from a first antenna and a second antenna; an A/V switch 3 for switching the audio/video signal extracted by the first tuner 1 and the second tuner 2; a first digital comb filter 4 for separating the video signal outputted from the A/V switch 3 into a luminance signal Y and a color signal C; a first video decoder 5 for converting the luminance signal Y and the color signal C separated by the first digital comb filter 4 into the luminance signal Y and a chrominance signal (U, V); a scaler 6 for matrix-transforming and processing the luminance and chrominance signals outputted from the first video decoder 5 and outputting an (R, G, B) signal; an MPEG-2 decoder 7 for image-processing the (R, G, B) signal processed by the scaler 6 to display it on a display device 8; a second digital comb filter 9 for separating the video signal outputted from the A/V switch 3 into a luminance signal Y and a color signal C; a second video decoder 10 for converting the luminance signal Y and the color signal C separated by the second digital comb filter 9 into the luminance signal Y and a chrominance signal (U, V); an MPEG-2 encoder 11 for encoding the luminance signal Y and the chrominance signal (U, V) by using an MPEG technology after matrix-transforming them in order to store them as a digital video signal; a controller 12 for controlling a current broadcasting play and a past broadcasting play; a data storage unit 13 for storing a broadcasting program encoded by the MPEG-2 encoder 11; and an image processing unit 14 for displaying a screen where a user can select an image of high quality.

Preferably, the PVR system may include a key input unit 15 so that a user can select a screen to be displayed through the key input unit 15.

Herein, the first tuner 1 and the A/V switch 3, the first digital comb filter 4 and the first video decoder 5 may construct a first signal processing unit for reproducing a broadcasting program in real-time.

In the mean time, the second tuner 2 and the A/V switch 3, the second digital comb filter 9, the second video decoder 10 and the MPEG-2 encoder 11 may constitute a second signal processing unit, which tunes into a broadcasting channel same as that tuned by the first tuner 1 and then performs an encoding process for storing.

By using the above-mentioned configuration, when a current mode for watching a current broadcasting is chosen, a broadcasting signal processed via a first path consisting of the first tuner 1 and the A/V switch 3, the first digital comb filter 4 and the first video decoder 5 may be displayed.

Meanwhile, when a past mode for watching a past broadcasting is selected, a broadcasting signal processed through a second path including the second tuner 2 and the A/V switch 3, the second digital comb filter 9, the second video decoder 10 and the MPEG-2 encoder 11 may be read from the data storage unit 13 and then displayed.

The first tuner 1 and the second tuner 2 tune into a channel among a plurality of broadcasting channels received from antennas.

The first tuner 1 extracts a synthetic image signal of a primary channel and the first tuner 2 also extracts a synthetic image signal of a secondary channel.

The A/V switch 3 outputs a switched signal in response to each input such as an external input.

The first digital comb filter 4 separates the video signal outputted from the A/V switch 3 for switching the audio/video signal extracted by the first tuner 1 into the luminance signal and the color signal

The first video decoder 5 performs a decoding process to transform the luminance and the color signals separated by the first digital comb filter 4 into the luminance signal and the chrominance signal.

The scaler 6 image-processes a digital image signal to output an (R, G, B) signal by using a matrix-transform of the luminance and the chrominance signals outputted from the first video decoder 5.

In addition to this, the scaler 6 receives an encoded digital image stored in the data storage unit 13 from the controller 12 and decodes the encoded digital image and converts a format of the decoded digital image to suit the display device 8.

The scaler 6 performs a matrix-conversion of the luminance and the chrominance signals inputted from the first video decoder 5. The scaler 6 converts the digital luminance signal Y and the chrominance signal (U, V) into the (R, G, B) signal and provides it to the display device 8 through the MPEG-2 decoder 7.

The MPEG-2 decoder 7 transforms the inputted (R, G, B) signal to a transmission signal (an LVDS or a TMDS signal) suitable for the display device 8. That is, the MPEG-2 decoder 7 image-processes the (R, G, B) signal processed by the scaler 6 to provide it to the display device 8.

The second digital comb filter 9 separates the video signal outputted from the A/V switch 3 for switching the audio/video signal tuned by the second tuner into the luminance signal and the color signal

The second video decoder 10 performs a decoding process to transform the luminance and the color signals separated by the second digital comb filter 9 into the luminance signal and the chrominance signal.

The MPEG-2 encoder 11 encodes a digital image signal outputted from the second video decoder 10 by using an MPEG technology in order to store it in the data storage unit 13.

The controller 12 controls the whole operation of the PVR system including a microprocessor. In detail, the controller 12 generates a control signal for tuning the first tuner 1 and the second tuner 2 to a broadcasting channel and controls a decoding process of a broadcasting signal and a storing and a wading process thereof.

The controller 12 provides the scaler 6 with a control signal to reproduce a broadcasting signal processed by the first video decoder 5 when a current mode for watching a current broadcasting is chosen. If a past mode for watching a past broadcasting is selected, the controller 12 reads a corresponding broadcasting signal from the data storage unit 13 and supplies it to the scaler 6.

For this purpose, the controller 12 transmits the encoded digital image signal to the scaler 6 through a PCI bus and stores data into the data storage unit 13 and reads data therefrom.

In the following, the data storage unit 13, e.g., HDD (hard disk drive) includes a broadcasting signal storage area for storing a broadcasting signal (compressed and encoded broadcasting program data) which a user want to record, an EPG (electronic program guide) information storage area for storing an EPG information and a user information storage area for storing information such as time information on a reservation recording and bit rate information (bit rate for use in recording a broadcasting signal) corresponding to various recording time, e.g., 0.5 h, 1 h, 1.5 h, 2 h and the like, and diverse image quality, e.g., HD and SD.

FIG. 2 is a screen displayed to a user in accordance with an embodiment of the present invention.

According to the embodiment of the present invention, the controller 12 controls the operation of the image processing unit 14 so that one broadcasting signal processed by the first signal processing unit and the other broadcasting signal processed by the second signal processing unit can be displayed on one display device at the same time through the use of a so-called twin picture function. A user can select and watch one screen of a first screen via a first path (the MPEG-2 encoding is not used) and a second screen via a second path (the MPEG-2 encoding is used). Therefore, the user can watch the screen of an improved image quality based on his/her choice while watching a broadcasting program on a PVR system.

In accordance with another embodiment a PVR system of the present invention, the user can select one of the first screen via the first path and the second screen via the second path when the user sets a time shift default. Further, the user can also select a screen that the user want to watch when PVR data is stored in the data storage unit.

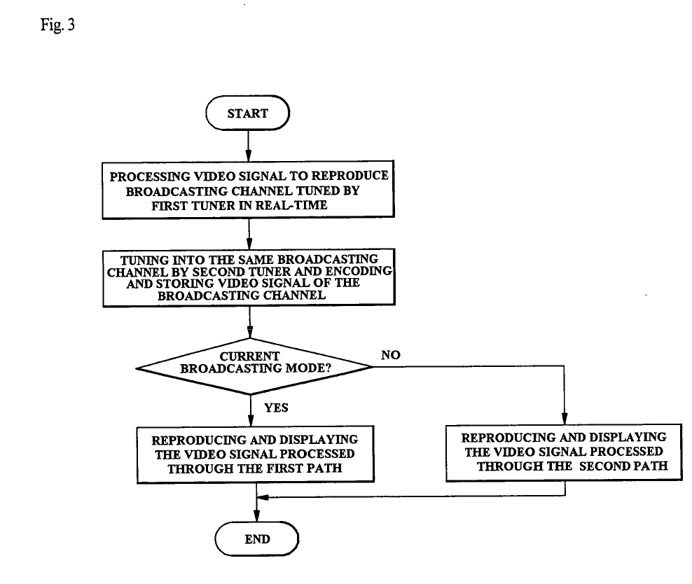

FIG. 3 is a flow chart of a PVR system in accordance with an embodiment of the present invention.

Referring to FIGS. 1 and 3, an image signal for reproducing a broadcasting channel tuned by the first tuner 1 in real-time is processed.

Further, a broadcasting channel same as that tuned by the first tuner 1 is tuned by the second tuner 2 and encoded and stored in the data storage unit 13.

The controller 12 determines whether a watching mode is a current mode for reproducing a broadcasting in real-time in response to a user's input.

As a result, if the watching mode is the current mode, a broadcasting signal processed through the first pass is reproduced via the scaler 6 and displayed.

On the contrary, if the watching mode is the past mode, corresponding broadcasting signal encoded and stored in the data storage unit 13 is read and decoded and reproduced via the scaler 6.

For example, if the present time is 10 hour, a signal of 10 hour can be processed along the first path and displayed. However, a past signal (temporarily stored) before 10 hour may be read from a hard disk drive and displayed as usual.

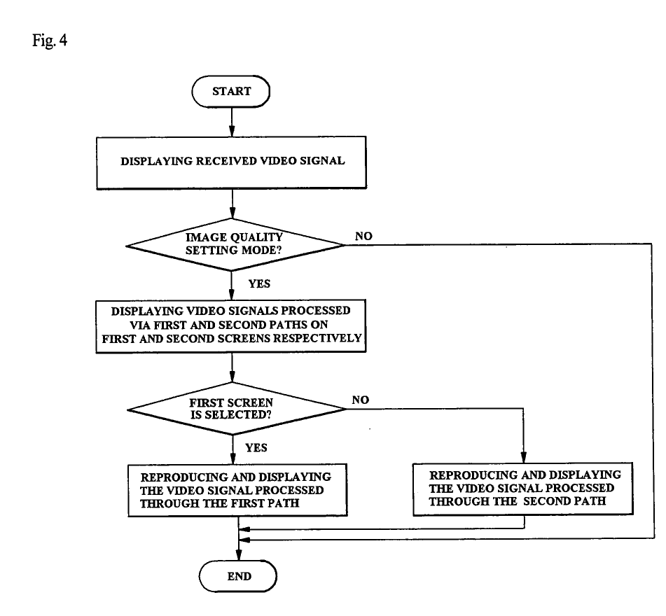

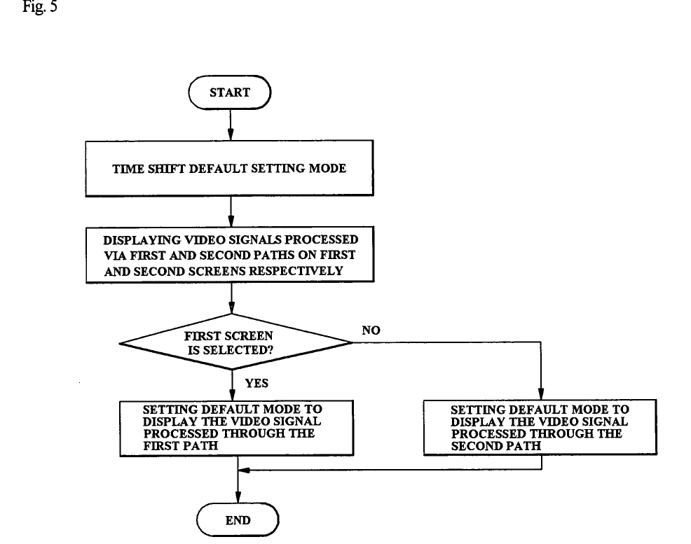

FIG. 4 is a flow chart of a PVR system in accordance with another embodiment of the present invention.

Referring to FIGS. 1 and 4, an image signal for reproducing a broadcasting channel tuned by the first tuner 1 in real-time is processed. Further, a broadcasting channel same as that tuned by the first tuner 1 is tuned by the second tuner 2 and encoded and stored in the data storage unit 13.

When a user selects an image quality setting mode through the key input unit 14, the controller displays a first screen via the first path and a second screen via the second path at the same time by using the twin picture function.

If the user selects the first screen, a broadcasting signal processed through the first path is reproduced and displayed in a full-screen via the scaler 6. Similarly, if the second screen is chosen, a broadcasting signal processed through the second path may be displayed in a full-screen.

FIG. 5 is a flow chart of a PVR system in accordance with still another embodiment of the present invention.

The user can set a time shift default to basically watch one of the first screen and the second screen as if the user selects the image quality setting mode.

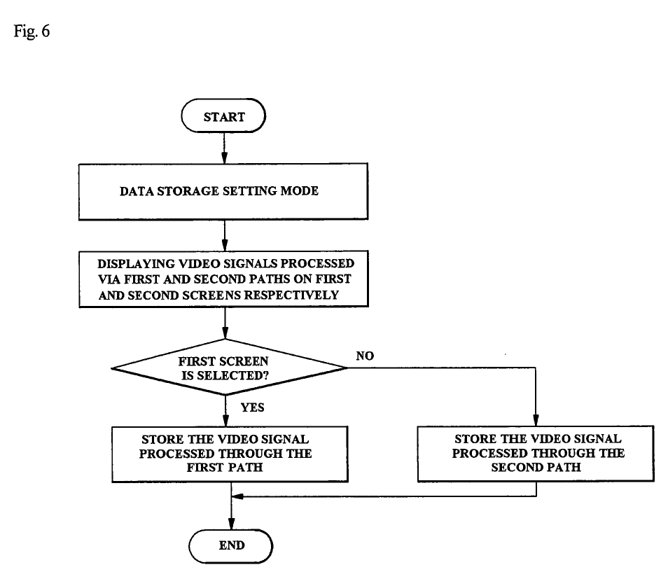

FIG. 6 is a flow chart of a PVR system in accordance with still another embodiment of the present invention.

The user can also store one of the first screen and the second screen as if the user selects the image quality setting mode.

As mentioned above, the present invention does not relate to a method for watching a current broadcasting by reproducing a previously recorded signal. That is, the present invention is directed to a method for watching a current broadcasting of a channel through the first path while recording a video signal of the same channel along the second path. Further, by displaying screens processed through different paths at the same time, the user can change a display path while watching a broadcasting. In addition, the user can set the time shift default as well as the data storage default.

In accordance with the present invention, when a user want to watch a broadcasting on the PVR system in real-time, the user doesn't have to watch a video signal which is recorded and then reproduced but the user can watch a video signal through the first path without using the MPEG technique.

Further, since a video signal of a current broadcasting is encoded by using the MPEG technique and then stored in the data storage unit, the user can watch the stored video signal when the user want to see a past broadcasting as usual.

Therefore, the user can watch a screen of an improved noise since the video signal is not encoded by using the MPEG technique when a current broadcasting is played.

Furthermore, by displaying screens processed through different paths at the same time, the user can change a display path while watching a broadcasting and can set the time shift default as well as the data storage default.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A PVR (personal video recorder) system comprising:
a first tuner and a second tuner for tuning into a channel among a plurality of broadcasting channels and extracting an audio/video signal from the tuned channel;
an A/V switch for switching the audio/video signal extracted by the first and the second tuner;
a first signal processing unit for image-processing the video signal outputted from the A/V switch to reproduce the broadcasting channel tuned by the first tuner in real-time;
a second signal processing unit for encoding the video signal outputted from the A/V switch to store the broadcasting channel tuned by the second tuner, which is the same as the broadcasting channel tuned by the first tuner;
a data storage unit for storing the video signal processed by the second signal processing unit; and
a controller for displaying the video signal processed by the fist signal processing unit or the video signal processed by the second signal processing unit and stored in the data storage unit.

2. The PVR system of claim 1, wherein the first signal processing unit includes:
a first digital comb filter for separating the video signal outputted from the A/V switch which switches the audio/video signal extracted by the first tuner into a luminance signal and a color signal; and
a first video decoder for performing a decoding process to transform the luminance and the color signal separated by the first digital comb filter into the luminance signal and a chrominance signal.

3. The PVR system of claim 1, wherein the second signal processing unit includes:
a second digital comb filter for separating the video signal outputted from the A/V switch which switches the audio/video signal extracted by the second tuner into a luminance signal and a color signal;
a second video decoder for performing a decoding process to transform the luminance and the color signal separated by the second digital comb filter into the luminance signal and a chrominance signal; and
an MPEG-2 encoder for encoding an digital image signal outputted from the second video decoder to store the encoded digital image signal in the data storage unit.

4. The PVR system of claim 2, further comprising:
a scaler for processing a digital image signal to output an (R, G, B) signal by using a matrix-transform of a luminance and a chrominance signals outputted from the first signal processing unit and decoding an encoded digital image; and
an MPEG-2 decoder for image-processing the (R, G, B) signal processed by the scaler to output the processed (R, G, B) signal to a display device.

5. The PVR system of claim 1, further comprising:
an image processing unit for processing the video signals processed by the first signal processing unit and the second signal processing unit to separate the video signals into a first screen and a second screen and display the first and the second screens.

6. The PVR system of claim 5, further comprising:
a key input unit connected to the controller for selecting a screen of the first and the second screens which a user want.

7. The PVR system of claim 1, wherein the first tuner and the second tuner are one of an ATSC tuner and an NTSC tuner.

8. The PVR system of claim 6, wherein the controller controls the image processing unit to display one of the video signal processed by the first signal processing unit and the video signal processed by the second signal processing unit according to a user's input regarding an image quality setting.

9. The PVR system of claim 6, wherein the controller controls the image processing unit to basically display one of the video signal processed by the first signal processing unit and the video signal processed by the second signal processing unit according to a user's input regarding a time shift default setting.

10. The PVR system of claim 6, wherein the controller stores one of the video signal processed by the first signal processing unit and the video signal processed by the second signal processing unit in the data storage unit according to a user's input regarding a data storage setting.

11. A method for reproducing a broadcasting signal in a PVR system, comprising the steps of:
(a) processing a video signal through a first path to reproduce a broadcasting channel tuned by a first tuner in real-time;
(b) tuning into a broadcasting channel by a second tuner, which is the same as the broadcasting channel tuned by the first tuner, and encoding and storing a video signal of the broadcasting channel along a second path; and
(c) reproducing and displaying the video signal processed in the step (a) if a current mode for watching a real-time broadcasting is chosen, and reading and reproducing the video signal stored in the step (b) if a past mode for watching a past broadcasting is selected.

12. A method for reproducing a broadcasting signal in a PVR system, comprising the steps of:
(a) processing a video signal through a first path to reproduce a broadcasting channel tuned by a first tuner in real-time;
(b) tuning into a broadcasting channel by a second tuner, which is the same as the broadcasting channel tuned by the first tuner, and encoding and storing a video signal of the broadcasting channel along a second path;
(c) selecting an image quality setting mode by a user; and
(d) reproducing and displaying the video signal processed in the step (a) if a mode for displaying the video signal processed through the first path is chosen, and reading and reproducing the video signal stored in the step (b) if a mode for displaying the video signal processed along the second path is selected.

13. A method for reproducing a broadcasting signal in a PVR system, comprising the steps of:
(a) processing a video signal through a first path to reproduce a broadcasting channel tuned by a first tuner in real-time;
(b) tuning into a broadcasting channel by a second tuner, which is the same as the broadcasting channel tuned by the first tuner, and encoding and storing a video signal of the broadcasting channel along a second path;
(c) selecting a time shift default setting mode by a user; and
(d) setting a default mode to reproduce and display the video signal processed in the step (a) if a mode for displaying the video signal processed through the first path is chosen, and setting the default mode to read and reproduce the video signal stored in the step (b) if a mode for displaying the video signal processed along the second path is selected.

14. A method for reproducing a broadcasting signal in a PVR system, comprising the steps of:
(a) processing a video signal through a first path to reproduce a broadcasting channel tuned by a first tuner in real-time;
(b) tuning into a broadcasting channel by a second tuner, which is the same as the broadcasting channel tuned by the first tuner, and encoding and storing a video signal of the broadcasting channel along a second path;
(c) selecting a time shift default setting mode in the PVR system by a user; and
(d) setting a default mode to reproduce and display the video signal processed in the step (a) if a mode for displaying the video signal processed through the first path is chosen, and setting the default mode to read and reproduce the video signal stored in the step (b) if a mode for displaying the video signal processed along the second path is selected.
